(19) United States
(12) Patent Application Publication
(10) Pub. No.: US 2012/0121973 A1
(43) Pub. Date: May 17, 2012

(54) NEGATIVE ACTIVE MATERIAL AND LITHIUM SECONDARY BATTERY WITH THE SAME, AND METHOD FOR MANUFACTURING THE LITHIUM SECONDARY BATTERY

(75) Inventors: Jung Wook SEO, Gyeonggi-do (KR); Tae Ho Kim, Gyeonggi-do (KR); Young Ku Lyu, Gyeonggi-do (KR)

(73) Assignee: SAMSUNG ELECTRO-MECHANICS CO., LTD.

(21) Appl. No.: 13/071,761

(22) Filed: Mar. 25, 2011

(30) Foreign Application Priority Data
Nov. 15, 2010 (KR) 10-2010-0113412

(51) Int. Cl. H01M 4/58; H01M 10/04; H01M 4/02; H01M 4/583; H01M 10/02; B05D 5/12; B82Y 40/00; B82Y 30/00

(52) U.S. Cl. 429/199; 427/58; 427/126.3; 429/209; 429/231.5; 429/218.1; 429/231.8; 429/188; 977/773; 977/895; 977/762; 977/734

(57) ABSTRACT

Disclosed herein is a negative active material for a lithium secondary battery. The negative active material according to an exemplary embodiment of the present invention includes nanoparticles having a multi layer structure in which a plurality of layers are stacked.

### CROSS REFERENCE(S) TO RELATED APPLICATIONS

This application claims the benefit under 35 U.S.C. Section [120, 119, 119(e)] of Korean Patent Application Serial No. 10-2010-0113412, entitled “Negative Active Material And Lithium Secondary Battery With The Same, And Method For Manufacturing The Lithium Secondary Battery” filed on Nov. 15, 2010, which is hereby incorporated by reference in its entirety into this application.

### BACKGROUND OF THE INVENTION

1. Technical Field

The present invention relates to a negative active material, an energy storage device with the same, and a method for manufacturing the energy storage device, and more particularly, to a negative active material capable of increasing charging capacity and reducing a change in capacity value due to repeated charging and discharging, a lithium secondary battery with the same, and a method for manufacturing the lithium secondary battery.

2. Description of the Related Art

Recently, studies on secondary batteries that can be reused as power supplies of mobile electronic apparatuses such as a cellular phone, a notebook computer, a personal digital assistant (PDA), a MP3 and the like, electric vehicles, and the like, by being charged or discharged, have been actively made. Currently, a secondary battery tends to be small and light with the rapid development of an electronic device technology and thus, attempts to improve the charging and discharging efficiency of the secondary battery have been variously conducted.

At present, a prevalently used lithium secondary battery uses a carbon-based material such as graphite, hard carbon, or the like, which can insert and separate lithium ions as a negative active material. However, when the negative active material is used as the carbon-based material, there is a limit to increase the intercalation and deintercalation efficiency of lithium ions to and from the negative active material. More specifically, a secondary battery has recently required higher capacity characteristics; however, when the negative active material is used as the carbon-based material having a simple bulk type, the insertion and separation efficiency of the lithium ions for the negative active material is low, such that there is a limit to increase the charging capacity of the lithium secondary battery. Further, a phenomenon of changing a capacity value due to a repetitive charging and discharging cycle occurs in a common lithium secondary battery, which should be improved.

Meanwhile, a common secondary battery has a relatively low charging and discharging rate, such that it's utility is limited in the field of requiring the rapid charging. Recently, an energy storage device called an ultra capacitor or a super capacitor exhibiting a higher charging and discharging rate than the secondary battery has been developed. However, the super capacitor has efficiency much lower than that of the secondary battery, which prevents the super capacitor from being used as the alternative device of the secondary battery. However, research for increasing the capacity of the supper capacitor has been actively conducted. One of the main targets in the secondary battery industries is to remarkably increase the charging and discharging rate of the secondary battery.

### SUMMARY OF THE INVENTION

An object of the present invention is to provide a negative active material capable of improving a capacity value and a charging and discharging rate of a secondary battery and a lithium secondary battery with the same.

Another object of the present invention is to provide a negative active material capable of reducing a change in capacity value due to a repetitive charging and discharging cycle of a secondary battery and a lithium secondary battery with the same.

Yet another object of the present invention is to provide a method for manufacturing a lithium secondary battery capable of improving a capacity value and a charging and discharging rate.

Still yet another object of the present invention is to provide a method for manufacturing a lithium secondary battery capable of reducing a change in capacity value due to a repetitive charging and discharging cycle.

According to an exemplary embodiment of the present invention, there is provided a negative active material including nanoparticles having a multi layer structure in which a plurality of layers are stacked.

The layers may be bonded to each other by Van der Waals intercalation.

A space between the layers may be a path through which carrier ions, which are charging and discharging reaction mediators of the secondary battery, are intercalated and discharged.

The nanoparticles may include at least any one of titanium disulfide (TiS₂), zirconium disulfide (ZrS₂), tungsten disulfide (WS₂), molybdenum disulfide (MoS₂), niobium disulfide (NbS₂), tantalum disulfide (TaS₂), tin disulfide (SnS₂), indium sulfide (InS), titanium diselenide (TiSe₂), zirconium diselenide (ZrSe₂), tungsten diselenide (WSe₂), molybdenum diselenide (MoSe₂), and niobium diselenide (NbSe₂).

The negative active material may further include: a conductive material imparting conductivity to the negative active material; and a binder increasing the application and bonding efficiency of the negative active material for a current collector, wherein the conductive material may includes at least any one of carbon black, ketjen black, carbon nanotube, graphene, and acetylene black and the binder may include a resin-based material.

According to another exemplary embodiment of the present invention, there is provided a lithium secondary battery, including: a positive electrode structure; a negative electrode structure disposed to face the positive electrode structure, having a separator disposed therebetween; and an electrolyte used as a moving mediator of carrier ions between the positive electrode structure and the negative electrode structure, wherein the negative electrode structure includes: a negative electrode current collector; and nanoparticles formed on a surface of the negative electrode current collector and having a multi layer structure in which a plurality of layers are stacked.

The layers may be bonded to each other by Van der Waals intercalation.

A space between the layers may be a path through which the carrier ions are intercalated and discharged to and from the negative active material.

The nanoparticles may include at least any one of titanium disulfide (TiS₂), zirconium disulfide (ZrS₂), tungsten disulfide (WS₂), molybdenum disulfide (MoS₂), niobium disulfide (NbS₂), tantalum disulfide (TaS₂), tin disulfide (SnS₂), indium sulfide (InS), titanium diselenide (TiSe₂), zirconium diselenide (ZrSe₂), tungsten diselenide (WSe₂), molybdenum diselenide (MoSe₂), and niobium diselenide (NbSe₂).

The electrolyte may include at least any one electrolytic salt of LiPF₆, LiBF₄, LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), and (CF₂)₂(SO₂)₂NLi.

According to another exemplary embodiment of the present invention, there is provided a method for manufacturing a lithium secondary battery, including: preparing nanoparticles having a multi layer structure; preparing a negative active material including the nanoparticles having a multi layer structure; preparing a negative electrode structure by coating the negative active material on a negative electrode current collector; preparing a positive electrode structure by coating the positive active material on a positive electrode current collector; and providing an electrolyte between the negative electrode structure and the positive electrode structure.

The preparing the nanoparticles of a multi layer structure may include: forming a mixing solution by adding a metal halide precursor and a sulfur precursor to an organic solvent; forming metal nanoparticles by heating the mixing solution at a preset reaction temperature; and separating the metal nanoparticles from the mixing solution.

The forming the metal nanoparticles may include controlling the number of layers of the metal nanoparticles by controlling the reaction temperature.

The controlling the number of layers of the metal nanoparticles may include: reducing the number of layers of the metal nanoparticles by increasing the reaction temperature; and increasing the number of layers of the metal nanoparticles by reducing the reaction temperature.

The metal halide precursor may include any one of titanium (Ti), tritium (Tu), indium (In), molybdenum (Mo), tungsten (W), zirconium (Zr), niobium (Nb), tin (Sn), and tantalum (Ta) and the sulfur precursor is any one of carbon disulfide (CS₂), diphenyldisulfide (PhSSPh), urea sulfide (NH₂CSNH₂), and CnH₂ₙ₊₁CSH, CnH₂ₙ₊₁SSCnH₂ₙ₊₁.

The positive active material may use at least any one of soft carbon, hard carbon, activated carbon, carbon aerogel, polyacrylonitrile (PAN), carbon nanofiber (CNF), activating carbon nanofiber (ACNF), vapor grown carbon fiber (VGCF), and a metal oxide.

The electrolyte may use at least any one of LiPF₆, LiBF₄, LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)2NLi, and (CF₂)₃(SO₂)₂NLi.

### BRIEF DESCRIPTION OF THE DRAWINGS

FIG. 1 is a diagram showing a lithium secondary battery according to an exemplary embodiment of the present invention;

FIGS. 2A to 2C are diagrams for explaining intercalation efficiency of lithium ions to a negative active material during the charging reaction of the lithium secondary battery shown in FIG. 1;

FIG. 3 is a diagram showing results of observing titanium disulfide nanoparticles prepared by a first exemplary embodiment of the present invention by using a transmission electron microscope;

FIG. 4 is a diagram showing results of observing zirconium disulfide nanoparticles prepared by the first exemplary embodiment of the present invention by using a transmission electron microscope;

FIG. 5 is a diagram showing an X-ray diffraction pattern of titanium disulfide nanoparticles prepared under a reaction temperature condition of 300° C. of the present invention;

FIG. 6 is a diagram showing a result of comparing an X-ray diffraction pattern of titanium disulfide nanoparticles prepared under a reaction temperature condition of 250° C. of the present invention with the X-ray diffraction pattern of the titanium disulfide nanoparticles shown in FIG. 5;

FIG. 7 is a diagram showing results of observing zirconium disulfide nanoparticles prepared by a second exemplary embodiment of the present invention by using a transmission electron microscope;

FIG. 8 is a diagram showing results of observing tungsten disulfide nanoparticles prepared by a third exemplary embodiment of the present invention by using a transmission electron microscope;

FIG. 9 is a diagram showing results of observing niobium disulfide nanoparticles prepared by a fourth exemplary embodiment of the present invention by using a transmission electron microscope;

FIG. 10 is a graph showing a change in capacity value according to the charging and discharging frequency of the lithium secondary battery according to the exemplary embodiment of the present invention; and

FIG. 11 is a graph showing a voltage profile of the lithium secondary battery according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements. Like reference numerals designate like elements throughout the specification.

Hereinafter, a negative active material and a method for manufacturing the same and a lithium secondary battery including the negative active material, and a method for manufacturing the same according to exemplary embodiments of the present invention will be described in detail with reference to the accompanying drawings.

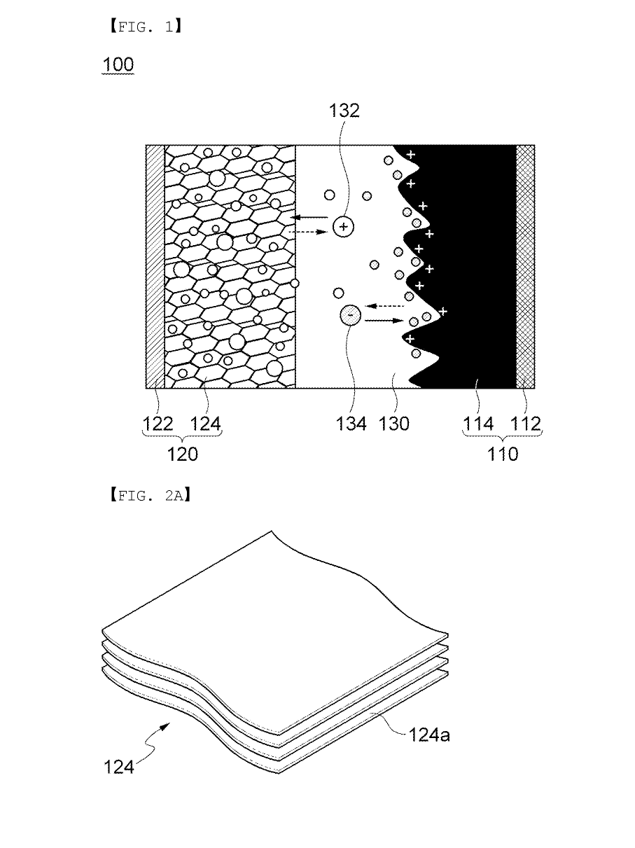

FIG. 1 is a diagram showing a lithium secondary battery according to an exemplary embodiment of the present invention. Referring to FIG. 1, a lithium secondary battery 100 according to an exemplary embodiment of the present invention may be configured to include a positive electrode structure 110, a negative electrode structure 120, and an electrolyte 130.

The positive electrode structure 110 may include a positive electrode current collector 112 and a positive active material layer 114 coated on the surface of the positive electrode current collector 112. Various kinds of metal foils may be used as the positive electrode current collector 112. As an example, an aluminum foil may be used as the positive electrode current collector 112. The positive active material 114 may include a material capable of adsorbing anions 134 within the electrolyte 130 during the charging operation of the lithium secondary battery 100. Various kinds of carbon materials may be used as the positive active material 114. For example, the positive active material 114 may include at least any one of soft carbon, hard carbon, activated carbon, carbon aerogel, polyacrylonitrile (PAN), carbon nanofiber (CNF), activating carbon nanofiber (ACNF), and vapor grown carbon fiber (VGCF). As another example, the positive active material 114 may include a metal oxide such as lithium transition metal, or the like.

The negative electrode structure 120 may include a negative electrode current collector 122 and a negative active material layer 124 coated on the surface of the negative electrode current collector 122. Various kinds of metal foils may be used as the negative electrode current collector 122. As one example, any one of copper foil and aluminum foil may be used as the negative electrode current collector 122. The negative active material 124 may use a material that can intercalate the cations 132 within the electrolyte 130 to the negative active material 124 during the charging operation of the lithium secondary battery 100. In addition, the negative active material 124 may include nanoparticles having a multi-layer structure. The detailed description of the negative active material 124 will be described below.

At least any one of the positive active material 114 and the negative active material 124 may further include additives such as a conductive material, a binder, or the like. As the conductive material, a material capable of providing conductivity to the positive active material 114 and the negative active material 124 may be used. To this end, various kinds of conductive materials may be used. As an example, as the conductive material, at least any one of carbon black, ketjen black, carbon nanotube, graphene, and acetylene black may be used. As another example, various kinds of metal powders may be used as the conductive material. As another example, acetylene black may be used as the conductive material. Further, as the binder, a material capable of improving the application efficiency and bonding efficiency of the positive and negative active materials 114 and 124 may be used. For example, various kinds of resins may be used as the binder.

The electrolyte 130 may include moving mediator of cations 132 and anions 134 between the positive electrode structure 110 and the negative electrode structure 120. The electrolyte 130 may be an electrolyte solution obtained by dissolving an electrolytic salt in a predetermined solvent. As the electrolytic salt, a lithium-based electrolytic salt may be used. The lithium-based electrolytic salt may be a salt including a lithium ion (Lil as carrier ions during the charging and discharging reaction of the energy storage device. For example, the lithium-based electrolyte salt may include at least any one of LiPF₆, LiBF₄, LiSbF₆, LiAsF₅, LiClO₄, LiN, CF₃SO₃, and LiC. Alternatively, the lithium-based electrolyte salt may include at least any one of LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)₂NLi, and (CF₂)₃(SO₂)₂NLi.

The solvent may include at least any one of annular carbonate and linear carbonate. For example, as the annular carbonate, at least any one of ethylene carbonate (EC), propylene carbonate (PC), butylene carbonate (BC), and vinyl ethylene carbonate (VEC) may be used. As the linear carbonate, at least any one of dimethyl carbonate (DMC), methylethyl carbonate (MEC), diethyl carbonate (DEC), methylpropyl carbonate (MPC), dipropyl carbonate (DPC), metylbutyl carbonate (MBC), and dibutyl carbonate (DBC) may be used. In addition, various kinds of ether, ester, and amide-based solvent may also be used.

Meanwhile, particles composing the negative active material 124 of the negative electrode structure 120 may have a multi-layer structure. For example, the negative active material 124 may include at least any one nanoparticles of titanium disulfide (TiS₂), zirconium disulfide (ZrS₂), tungsten disulfide (WS₂), molybdenum disulfide (MoS₂), niobium disulfide (NbS₂), tantalum disulfide (TaS₂), tin disulfide (SnS₂), indium sulfide (InS), titanium diselenide (TiSe₂), zirconium diselenide (ZrSe₂), tungsten diselenide (WSe₂), molybdenum diselenide (MoSe₂), and niobium diselenide (NbSe₂). The nanoparticles may be formed in a multi-layer structure in which a plurality of layers are stacked. Each layer may be generally provided in a sheet or film type. Each of the layers is bonded to each other by Van der Waals intercalation having a weak bonding force. Therefore, the cations 132 may be easily intercalated to the space between the layers of the negative active material 124 or easily discharged from the space between the layer, during the charging and discharging operation of the lithium secondary battery 100. Further, the negative active material 124 having the above-mentioned multi-layer structure may have a stable structure that is less deformed by external force, stimulation, etc., thereby making it possible to reduce the charging and discharging efficiency due to the repetitive charging and discharging operation cycle. Therefore, the lifespan and stability of the lithium secondary battery 100 can be increased.

During the charging operation of the above-mentioned lithium secondary battery 100, the intercalation principle of the cations 132 to the negative active material 124 is as follows.

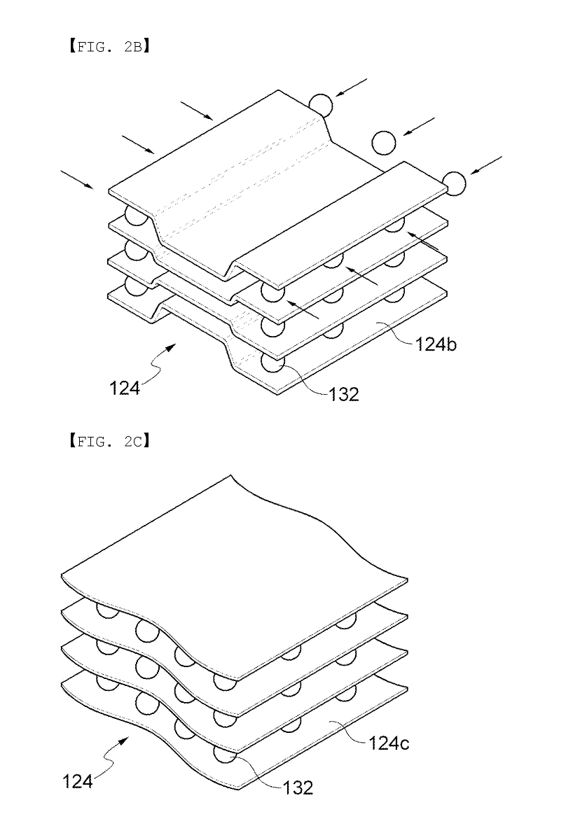

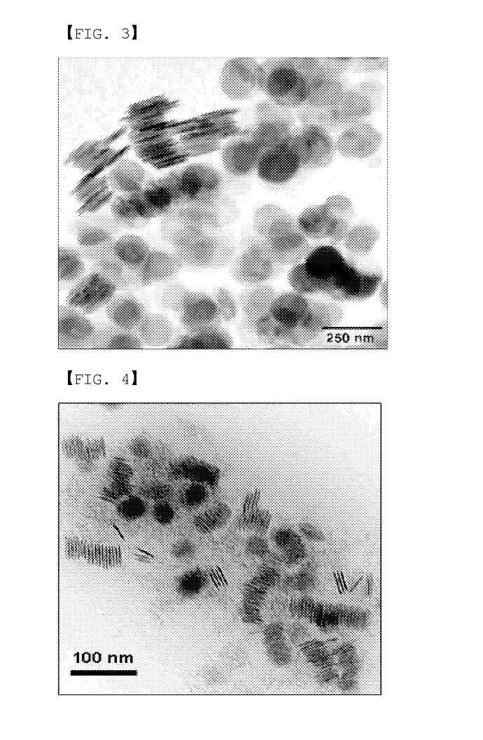

FIGS. 2A to 2C are diagrams for explaining intercalation efficiency of lithium ions to a negative active material during the charging reaction of the lithium secondary battery shown in FIG. 1. In more detail, FIG. 2A is a diagram showing the negative active material before the charging operation is initiated. FIG. 2B is a diagram showing a shape in which the cations are intercalated to the negative active material when the charging operation of the lithium secondary battery is initiated. FIG. 2C is a diagram showing a shape in which the cations are intercalated to the negative active material when the charging operation of the lithium secondary battery is completed.

Referring to FIG. 2A, the negative active material 124 has the multi-layer structure in which the plurality of layers 124a are stacked, wherein the layers 124a may be bonded to each other by the Van der Waals intercalation.

Referring to FIG. 2B, when the charging operation of the lithium secondary battery is initiated, the cations 132 may be inserted into the space between layers 124a of the negative active material 124. In this case, the layers 124a are bonded to each other by the relatively very weak Van der Waals intercalations, such that the cations 132 are effectively intercalated and inserted into the space between the layers 124a. That is, the negative active material 124 has a remarkably small resistance when the cations 132 are intercalated to the space between the layers, thereby making it possible to remarkably increase the intercalation efficiency of the cations 132. In this case, the charging rate of the lithium secondary battery may be increased. Further, the layers 124a have a laminar structure, such that the cations 132 may be inserted toward the layers 124a from at least four side directions of the layers 124a.

Referring to FIG. 2C, when the charging operation of the lithium secondary battery is completed, the space between the layers 124a of the negative active material 124 may be filled with the cations 132. In this case, the interval between the layers 124a is increased by the cations 132, such that the structure thereof may be deformed. However, since the layers 124a have a multi-layer structure, the interval between the layers 124a is simply increased and reduced by the intercalation and deintercalation of the cations 132, such that the structure thereof may not be deformed into other shapes or the structure thereof may not be collapsed. Therefore, the negative active material 124 has the stable structure even though the charging and discharging operation is repeated, such that the change in capacity value of the lithium secondary battery may be reduced.

As described above, the lithium secondary battery according to the exemplary embodiment of the present invention may be configured to include the positive electrode structure 110, the negative electrode structure 120, and the electrolyte 130, wherein the negative electrode structure 120 may include the negative active material 124 having nanoparticles of a multi-layer structure in which each of the layers is bonded to each other by the Van der Waals intercalations. In this case, the Van der Waals intercalations has the relatively weak bonding force, such that the cations 132 can be easily intercalated or discharged to and from the space between the layers 124a. In addition, the negative active material 124 having the above-mentioned multi-layer structure may implement the stable structure in which the multi-layer structure is less likely to be deformed or collapsed since the cations 132 are intercalated and discharged by using the space between the layers 124a.

In addition, the lithium secondary battery according to the present invention includes the negative active material composed of nanoparticles having the multi-layer structure bonded by the relatively weak intercalations to effectively intercalate cations to the space between the sheets of the negative active material, thereby making it possible to improve the capacity value of the secondary battery and has the multi-layer structure in which the negative active material 124 is stable, thereby making it possible to minimize the change in capacity value due to the repetitive charging and discharging cycle.

Hereinafter, the method for manufacturing nanoparticles having a multi-layer structure for the negative active material of the lithium secondary battery according to the exemplary embodiment of the present invention will be described in detail.

The method for manufacturing nanoparticles having a laminar structure may largely include preparing a mixing solution by putting an organic solvent, a metal halide precursor, a sulfur precursor in a reaction container and agitating them therein, forming a reactant by heating and reacting the mixing solution, precipitating metal sulfide nanoparticles in the reactant, and separating the metal sulfide nanoparticles.

First, at the preparing the mixing solution, the metal halide precursor may be a metal compound satisfying the conditions of MₐX_{b} (M is a metal, 1≦a≦7, X═F, Cl, Br, I, etc., 1≦b≦9). The M may be any one of titanium (Ti), tritium (Tu), indium (In), molybdenum (Mo), tungsten (W), zirconium (Zr), niobium (Nb), tin (Sn), and tantalum (Ta). The sulfur precursor may be any one of carbon disulfide, diphenyldisulfide (PhSSPh), urea sulfide (NH₂CSNH₂), CnH₂ₙ₊₁CSH, CnH₂ₙ₊₁SSCnH₂ₙ₊₁.

As the organic solvent, an organic solvent including amine may be used. As an example, the organic solvent may include organic amines (CnNH₂, Cn: hydrocarbon, 4≦n≦30) such as at least any one of oleyl amine, dodecyl amine, lauryl amine, octyl amine, triocytl amine, dioctyl amine, and hexadecyl amine. As another example, the organic solvent may include at least any one of ester-based compound (CnOCn, Cn: hydrogen carbon, 4≦n≦30), hydrocarbons (CnH₂ₙ₊₁, 7≦n≦30), unsaturated hydrocarbons (CnH₂ₙ, 7≦n≦30), and organic acid (CnCOOH, Cn: hydrocarbon, 5≦n≦30) The ether-based compound may include at least any one of trioctylphosphine oxide (TOPO), alkylphosphine, octyl ether, benzyl ether, and phenyl ether. The hydrocarbons may include at least any one of hexadecane, heptadecane, and octadecane. The unsaturated hydrocarbons may include at least any one of octane, heptadecane, and octadecane. The organic acid may include at least any one of oleic acid, lauric acid, stearic acid, mysteric acid, and hexadecanoic acid.

Meanwhile, as the reactant determining the kind of the nanoparticles having a laminar structure, the surfactant may be additionally used. As an example, as the surfactant, various kinds of organic amine (CnNH₂, Cn: hydrocarbon, 4≦n≦30) may be used. As an example, as the surfactant, at least any one of oleyl amine, dodecyl amine, lauryl amine, octyl amine, triocytl amine, dioctyl amine, and hexadecyl amine may be used. As another example, as the surfactant, various kinds of alkane thiol (CnSH, Cn; hydrocarbon, 4≦n≦30) may be used. For example, as the surfactant, at least any one of the hexadecane thiol, dodecane thiol, heptadecane thiol, and octadecane thiol may be used.

At the forming the reactant by heating and reacting the mixing solution, the metal halide precursor is modified into metal sulfide, such that the metal sulfide nanoparticles having a laminar structure may be formed. The heating temperature of the mixing solution may be approximately 80° C. to 350° C. In addition, the reacting time of the metal halide precursor may be controlled to be approximately 1 minute to 8 hours.

The precipitating the metal sulfide nanoparticles within the reactant may be made by adding at least any one of ethanol and acetone to the reactant. The separating the metal sulfide nanoparticles may use the centrifugal separator and may be made by using a filtering method, etc.

Meanwhile, the forming the reactant by heating and reacting the mixing solution controls at least any one reacting temperature of the metal halide precursor and the sulfur precursor, the number of layers of nanoparticles having a multi-layer structure can be controlled. For example, as the reaction temperature of the metal halide precursor or the sulfur precursor is increased, the number of layers of nanoparticles may be reduced. On the other hand, as the reaction temperature of the metal halide precursor or the sulfur precursor is reduced, the number of layers of nanoparticles may be increased That is, the reaction temperature of the metal halide precursor and the sulfur precursor may be in inversely proportionate to the number of layers of nanoparticles.

Next, the method for manufacturing the above-mentioned negative active material and the lithium secondary battery with the same will be described in more detail. The following Examples are examples implementing the above-mentioned technical principle and the technical principle of the present invention is not limited to the following Examples.

### EXAMPLE 1

### Method for Preparing TiS₂ Nanoparticles

90 μl of titanium tetrachloride (TiCl₄) and 3 g of purified oleyl amine were put in a predetermined reaction container and were heated at 300° C. under an argon process atmosphere. About 0.12 Ml of carbon disulfide (CS₂) was injected into the reaction container to prepare a mixing solution. The mixing solution was heated at 300° C. The mixing solution was maintained for approximately 30 minutes under a temperature condition of 300° C. and the reaction container was then cooled at normal temperature. The nanoparticles were precipitated by adding 20 Ml of acetone to the mixing solution. The precipitated titanium disulfide (TiS₂) nanoparticles were recovered by using the centrifugal separator.

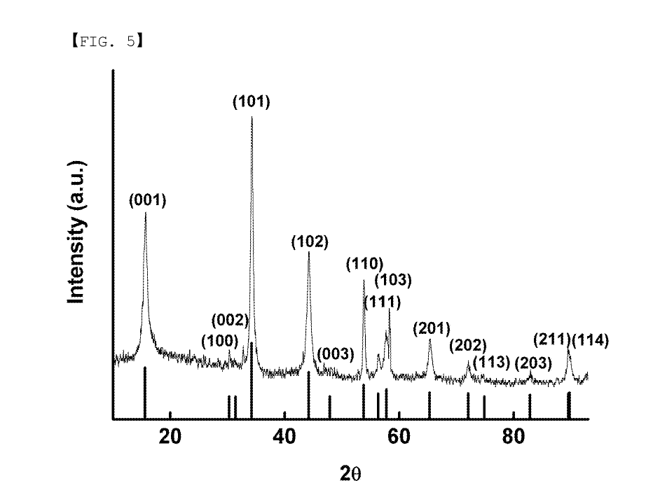

Herein, 20 μl of solution containing the prepared titanium disulfide nanoparticles was disposed on a TEM grid coated with a carbon film and was dried for about 20 minutes. The results observed by a transmission electron microscope (EE-TEM, Zeiss, acceleration voltage 100 kV) were shown in FIGS. 3 and 4.

FIG. 3 is a diagram showing results of observing titanium disulfide nanoparticles prepared by a first exemplary embodiment of the present invention by using a transmission electron microscope and FIG. 4 is a diagram showing results of observing zirconium disulfide nanoparticles prepared by the first exemplary embodiment of the present invention by using a transmission electron microscope. It was confirmed from FIGS. 3 and 4 that the structure of the prepared titanium disulfide nanoparticles has a multi layer structure of at least two layers.

Method for Controlling the Number of Layers of TiS₂ Nanoparticles

Meanwhile, the number of layers of the titanium disulfide nanoparticles having the multi layer structure may be formed by controlling the reaction temperature of the mixing solution at the forming the reactant by heating the mixing solution. In other words, the mixing solution was prepared in the same manner as the method for preparing titanium disulfide nanoparticles and only the heating temperature of the mixing solution was lowered to 250° C. and the titanium disulfide nanoparticles was prepared. The reaction time and other process conditions were set to be the same.

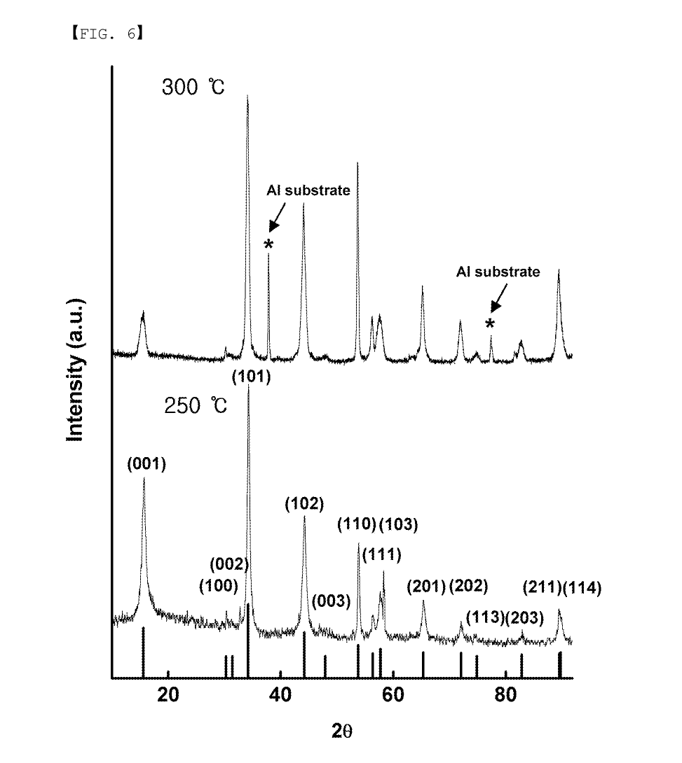

FIG. 5 is a diagram showing an X-ray diffraction pattern of titanium disulfide nanoparticles prepared under a reaction temperature condition of 300° C. of the present invention and FIG. 6 is a diagram showing a result of comparing an X-ray diffraction pattern of titanium disulfide nanoparticles prepared under a reaction temperature condition of 250° C. of the present invention with the X-ray diffraction pattern of the titanium disulfide nanoparticles shown in FIG. 5.

It could be confirmed from FIGS. 5 and 6 that as a result of comparing the X-ray diffraction analysis pattern obtained when carbon disulfide CS₂ was mixed at 300° C. with the X-ray diffraction analysis pattern obtained at 250° C., the peak intensity and width of (001) surface when the carbon disulfide (CS₂) was mixed at 300° C. is weaker and wider than the peak intensity and width of (001) surface obtained by mixing the carbon disulfide CS₂. Therefore, it could be confirmed that the number of layers having the nanoparticles having a laminar structure obtained at 300° C. according to the present exemplary embodiment is smaller than the number of layers having nanoparticles having a laminar structure prepared at 250° C. Therefore, at the forming the reactant by heating and reacting the mixing solution, it was be confirmed that the number of layers of nanoparticles having the multi layer structure can be controlled by controlling the reaction temperature of at least any one of the metal halide precursor and the sulfur precursor. That is, it was confirmed that the reaction temperature of the metal halide precursor and the sulfur precursor is in inversely proportionate to the number of layers of nanoparticles.

### EXAMPLE 2

### Method for Preparing ZrS₂ Nanoparticles

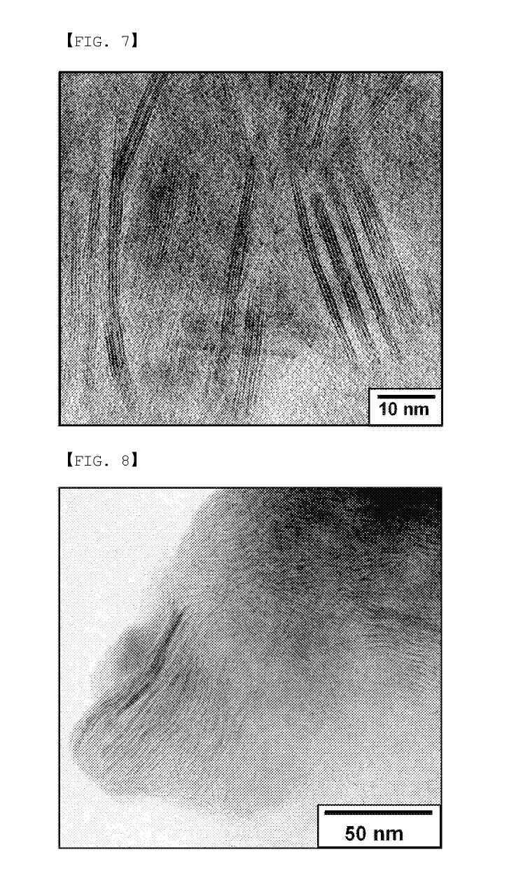

As compared to the method for manufacturing above-mentioned titanium disulfide nanoparticles, the remaining preparing processes except that zirconium tetrachloride (ZrCl₄) was used instead of titanium tetrachloride (TiCl₄) were equally performed to prepare the zirconium disulfide nanoparticles having a multi layer structure. FIG. 7 is a diagram showing results of observing zirconium disulfide nanoparticles prepared by a second exemplary embodiment of the present invention by using a transmission electron microscope. It was confirmed from FIG. 7 that the zirconium disulfide nanoparticles prepared according to the second exemplary embodiment of the present invention have a multi layer structure.

### EXAMPLE 3

### Preparing WS₂ Nanoparticles

As compared to the method for manufacturing above-mentioned titanium disulfide nanoparticles, the remaining preparing processes except that tungsten disulfide (WS₂) was used instead of titanium tetrachloride (TiCl₄) were equally or similarly performed to prepare the tungsten disulfide nanoparticles having a multi layer structure.

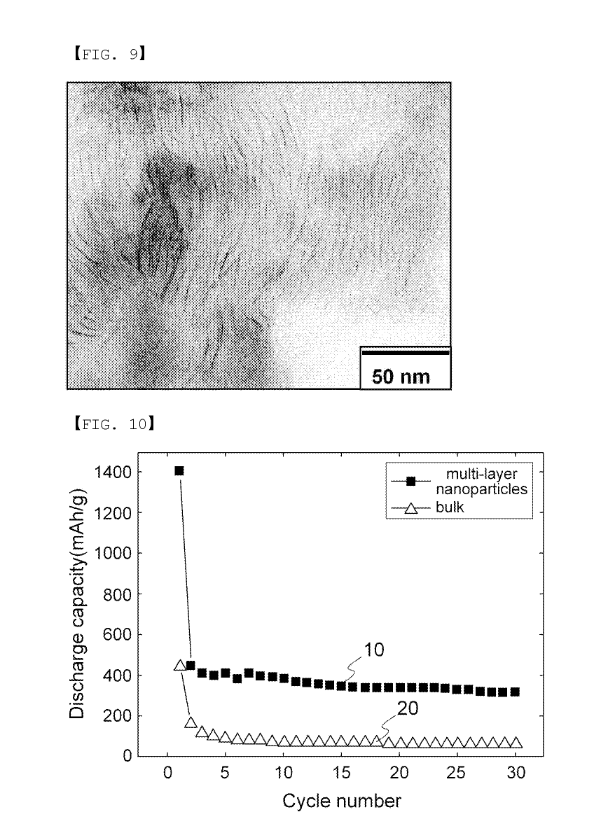

FIG. 8 is a diagram showing results of observing tungsten disulfide nanoparticles prepared by a third exemplary embodiment of the present invention by using a transmission electron microscope. It was confirmed from FIG. 8 that the tungsten disulfide nanoparticles prepared according to the third exemplary embodiment of the present invention have a multi layer structure.

### EXAMPLE 4

### Preparing NbS₂ Nanoparticles

As compared to the method for manufacturing above-mentioned titanium disulfide nanoparticles, the remaining preparing processes except that niobium disulfide NbS₂ was used instead of titanium tetrachloride (TiCl₄) were equally or similarly performed to prepare the niobium disulfide nanoparticles having a multi layer structure.

FIG. 9 is a diagram showing results of observing niobium disulfide nanoparticles prepared by a fourth exemplary embodiment of the present invention by using a transmission electron microscope. It was confirmed from FIG. 9 that the titanium disulfide nanoparticles prepared according to the fourth exemplary embodiment of the present invention have a multi layer structure.

Method for Manufacturing Lithium Secondary Battery

The nanoparticles having a multi layer structure prepared as described above uses the titanium disulfide nanoparticles to prepare the lithium secondary battery. In more detail, the titanium disulfide nanoparticles prepared as described above, the super P carbon black, the polyvinylidene fluoride binder were mixed at a weight ratio of approximately 8:1:1 and then, modified into a pellet. The lithium electrode was used as the counter electrode. Further, LiPF₆ was mixed in a solution configured of at a volume ratio of 1:1 of ethylene carbonate and diethylene carbonate to prepare 1M LiPF₆ electrolyte composition. The lithium secondary battery having a coin cell type was prepared by using the above-mentioned prepared electrodes and electrolyte solution. The electrode characteristics of the secondary battery were evaluated up to 30 charging and discharging cycles under the fixing current condition of 50 Ma/g in the voltage range of approximately 5 mV and 2V.

Meanwhile, as the comparative example of the lithium secondary battery prepared under the above-mentioned conditions, the lithium secondary battery was manufactured in the same method as the above-mentioned method by using the titanium disulfide nanoparticles having a bulk type and was then evaluated under the same conditions.

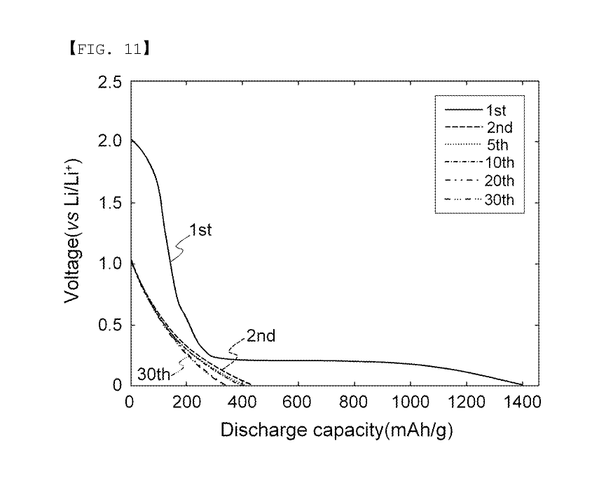

FIG. 10 is a graph showing a change in capacity value according to the charging and discharging frequency of the lithium secondary battery according to the exemplary embodiment of the present invention. In a graph shown in FIG. 10, a horizontal axis represents the charging and discharging cycle frequency and a vertical axis represents the discharge capacity value of the lithium secondary battery. FIG. 11 is a graph showing a voltage profile of the lithium secondary battery according to the exemplary embodiment of the present invention. In a graph shown in FIG. 11, a horizontal axis represents discharge capacity and a vertical axis represents voltage. It was confirmed from FIG. 10 that the lithium secondary battery 10 to which the titanium disulfide nanoparticle technology having a multi layer structure is applied has remarkably high capacity value according to the charging and discharging cycle repetition, as compared to the lithium secondary battery 20 to which the titanium disulfide nanoparticle technology having a bulk type is applied. That is, the lithium secondary battery according to the exemplary embodiment of the present invention can improve the capacity value, as compared to the lithium secondary battery in which the negative active material is composed of the nanoparticles having a bulk type. Further, as shown in FIG. 11, the lithium secondary battery according to the exemplary embodiment of the present invention showed that the stable lifespan performance was obtained according to the results obtained by performing the charging and discharging cycles 30 times and the charging rate was remarkably increased, as compared to the lithium secondary battery in which the negative active material is composed of nanoparticles having a bulk type.

As set forth above, the negative active material according to the present invention includes nanoparticles having a multi-layer structure in which each of the layers is bonded to each other by relatively weak intercalation, thereby making it possible to implement a structure in which the mediator of the charging and discharging reaction of the secondary battery, i.e., the carrier ions are intercalated and discharged to and from the space between each of the layers. Therefore, the negative active material according to the present invention improves the intercalation and discharge efficiency of the carrier ions, thereby making it possible to improve the capacity of the secondary battery.

Further, the negative active material according to the present invention is composed of nanoparticles having the multi-layer structure in which the plurality of layers are stacked, such that it can have a stable structure in which the multi-layer structure is less likely to be deformed and collapsed even though the mediator of the charging and discharging reaction of the secondary battery, i.e., the carrier ions are intercalated and discharged through the space between the layers Therefore, when the negative active material according to the present invention is used as the negative electrode structure of the lithium secondary battery, the change in capacity value according to the repetitive charging and discharging cycle of the lithium secondary battery can be minimized.

In addition, the lithium secondary battery according to the present invention includes the negative active material composed of nanoparticles having the multi-layer structure bonded by the relatively weak attractions to effectively intercalate cations to the space between the sheets of the negative active material, thereby making it possible to improve the capacity value of the secondary battery and has the multi-layer structure in which the negative active material is stable, thereby making it possible to minimize the change in capacity value due to the repetitive charging and discharging cycle.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A negative active material including nanoparticles having a multi layer structure in which a plurality of layers are stacked.

2. The negative active material according to claim 1, wherein the layers are bonded to each other by Van der Waals intercalation.

3. The negative active material according to claim 1, wherein a space between the layers is a path through which carrier ions, which are charging and discharging reaction mediators of the secondary battery, are intercalated and deintercalated.

4. The negative active material according to claim 1, wherein the nanoparticles include at least any one of titanium disulfide (TiS₂), zirconium disulfide (ZrS₂), tungsten disulfide (WS₂), molybdenum disulfide (MoS₂), niobium disulfide (NbS₂), tantalum disulfide (TaS₂), tin disulfide (SnS₂), indium sulfide (InS), titanium diselenide (TiSe₂) zirconium diselenide (ZrSe₂), tungsten diselenide (WSe₂), molybdenum diselenide (MoSe₂), and niobium diselenide (NbSe₂).

5. The negative active material according to claim 1, wherein the negative active material further includes:
a conductive material imparting conductivity to the negative active material; and
a binder increasing the application and bonding efficiency of the negative active material for a current collector,
the conductive material including at least any one of carbon black, ketjen black, carbon nanotube, graphene, and acetylene black, and
the binder including a resin-based material.

6. A lithium secondary battery, comprising:
a positive electrode structure;
a negative electrode structure disposed to face the positive electrode structure, having a separator disposed therebetween; and
an electrolyte used as a moving mediator of carrier ions between the positive electrode structure and the negative electrode structure,
wherein the negative electrode structure includes:
a negative electrode current collector; and
nanoparticles formed on a surface of the negative electrode current collector and having a multi layer structure in which a plurality of layers are stacked.

7. The lithium secondary battery according to claim 6, wherein the layers are bonded to each other by Van der Waals intercalation.

8. The lithium secondary battery according to claim 6, wherein a space between the layers is a path through which the carrier ions are intercalated and deintercalated to and from the negative active material.

9. The lithium secondary battery according to claim 6, wherein the nanoparticles include at least any one of titanium disulfide (TiS₂), zirconium disulfide (ZrS₂), tungsten disulfide (WS₂), molybdenum disulfide (MoS₂), niobium disulfide (NbS₂), tantalum disulfide (TaS₂), tin disulfide (SnS₂), indium sulfide (InS), titanium diselenide (TiSe₂), zirconium diselenide (ZrSe₂), tungsten diselenide (WSe₂), molybdenum diselenide (MoSe₂), and niobium diselenide (NbSe₂).

10. The lithium secondary battery according to claim 6, wherein the electrolyte includes at least any one electrolytic salt of LiPF₆, LiBF₄, LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), and (CF₂)₂(SO₂)₂NLi.

11. A method for manufacturing a lithium secondary battery, comprising:
preparing nanoparticles having a multi layer structure;
preparing a negative active material including the nanoparticles having a multi layer structure;
preparing a negative electrode structure by coating the negative active material on a negative electrode current collector;
preparing a positive electrode structure by coating the positive active material on a positive electrode current collector; and
providing an electrolyte between the negative electrode structure and the positive electrode structure.

12. The method for manufacturing a lithium secondary battery according to claim 11, wherein the preparing the nanoparticles of a multi layer structure includes:
forming a mixing solution by adding a metal halide precursor and a sulfur precursor to an organic solvent;
forming metal nanoparticles by heating the mixing solution at a preset reaction temperature; and
separating the metal nanoparticles from the mixing solution.

13. The method for manufacturing a lithium secondary battery according to claim 12, wherein the forming the metal nanoparticles includes controlling the number of layers of the metal nanoparticles by controlling the reaction temperature.

14. The method for manufacturing a lithium secondary battery according to claim 13, wherein the controlling the number of layers of the metal nanoparticles includes:
reducing the number of layers of the metal nanoparticles by increasing the reaction temperature; and
increasing the number of layers of the metal nanoparticles by reducing the reaction temperature.

15. The method for manufacturing a lithium secondary battery according to claim 12, wherein the metal halide precursor includes any one of titanium (Ti), tritium (Tu), indium (In), molybdenum (Mo), tungsten (W), zirconium (Zr), niobium (Nb), tin (Sn), and tantalum (Ta) and the sulfur precursor is any one of carbon disulfide, diphenyldisulfide (PhSSPh), urea sulfide (NH₂CSNH₂), and CnH₂ₙ₊₁CSH, CnH₂ₙ₊₁SSCnH₂ₙ₊₁.

16. The method for manufacturing a lithium secondary battery according to claim 11, wherein the positive active material uses at least any one of soft carbon, hard carbon, activated carbon, carbon aerogel, polyacrylonitrile (PAN), carbon nanofiber(CNF), activating carbon nanofiber (ACNF), vapor grown carbon fiber (VGCF), and a metal oxide.

17. The method for manufacturing a lithium secondary battery according to claim 11, wherein the electrolyte uses at least any one of LiSbF₆, LiAsF₅, LiClO₄, LiN, CF₃SO₃, LiC, LiN(SO₂CF₃)₂, LiN(SO₂C₂F₅)₂, LiC(SO₂CF₃)₂, LiPF₄(CF₃)₂, LiPF₃(C₂F₅)₃, LiPF₃(CF₃)₃, LiPF₅(iso-C₃F₇)₃, LiPF₅(iso-C₃F₇), (CF₂)₂(SO₂)₂NLi, and (CF₂)₃(SO₂)₂NLi.
